(19) United States
(12) Patent Application Publication
(10) Pub. No.: US 2011/0115685 A1
(43) Pub. Date: May 19, 2011

(54) RFID TAG ANTENNA USING DOUBLE-OPEN ENDS COUPLER STRUCTURE

(75) Inventor: CHIH-CHEN CHANG, Taipei County (TW)

(73) Assignee: ClarIDy Solutions, Inc., Taipei (TW)

(21) Appl. No.: 12/627,070

(22) Filed: Nov. 30, 2009

(30) Foreign Application Priority Data
Nov. 16, 2009 (TW) 098138796

(51) Int. Cl. H01Q 9/04; H01P 11/00; H01Q 9/16; H01Q 1/50

(52) U.S. Cl. 343/793; 29/600; 343/700 MS; 343/850

(57) ABSTRACT

The present disclosure relates to an RFID tag, more particularly to, a UHF band RFID tag antenna using a double-open ends coupler; wherein the structure thereof is using a half wavelength dipole antenna with a double-open ends coupler mutually coupled to each other, and the RFID chip is disposed upon the coupler, and the coupler is designed to be double-open ends structure so as to, rather than prior arts, enhance the radiation without compromising the impedance match between the antenna and the chip.

### BACKGROUND OF THE INVENTION

1. Field of the Invention

The present invention relates to an RFID tag antenna, more particularly, to an RFID tag antenna using double-open ends coupler structure.

2. Description of the Prior Arts

RFID is a communication technology, which can identify a specific target and read the corresponding data via a wireless signal without a mechanical or optical contact between an identifying system and the specific target. As the wireless RFID technology became more popular, many hand held devices are installed with RFID antenna.

RFID tag antenna can be categorized into, according to its operating frequencies, low-frequency antenna, high-frequency antenna, ultra-high frequency antenna, and microwave antenna. The low-frequency antenna is operating within the range of 125 kHz to 134 kHz; the high frequency antenna is operating at 13.56 MHz; the ultra-high frequency antenna is operating within the range of 840 MHz ˜960 MHz; and microwave antenna is operating within the range of 2.45 GHz˜5.8 GHz. Generally speaking, the wireless RFID tag antenna installed in the hand held electronic apparatus belongs to an ultra-high frequency antenna, and the ultra-high frequency antenna uses radiation for its transmission.

U.S. Pat. No. 7,545,928 discloses an RFID tag 10 and its impedance match method, as illustrated in FIG. 1, which comprises an antenna body 101 and a couple loop 102, disposed on a substrate 103 with two feed-in points 102a/102b. For the reason of impedance match, the couple loop 102 can be deemed as a small-scale inductor, barely having any radiation function. Alternatively, in order to achieve the impedance match between the antenna and its chip, inevitably, the small-scaled loop 102, barely having any radiation function, (the small couple loop 102 is usually smaller than 30% of the size of the antenna body 101) so as to ensure the input impedance for the antenna has appropriate inductive reactance and accordingly the capacitive reactance of the chip can be eliminated and further a conjugate match can be achieved. In the case of the match, the return loss of the input port can be illustrated in FIG. 1A, and its impedance characteristics can be further illustrated in FIG. 2 (where the real part of the input impedance of the antenna is denoted as Ra, the imaginary part is denoted as Xa; and, the real part of the input impedance of the chip is denoted as Rc, and the imaginary part is denoted as Xc).

Accordingly, in view of the above drawbacks, it is an imperative that a novel antenna, more particularly, a novel antenna using double-open ends coupler are designed so as to solve the drawbacks as the foregoing.

### SUMMARY OF THE INVENTION

In view of the disadvantages of prior art, the primary object of the present invention is to suggest a new UHF band RFID tag antenna, which can broaden its bandwidth and enhance its radiation.

Hence, the present invention relates to an apparatus for an RFID tag antenna characterized in broad band and high radiation, comprising: an antenna body; and a double-open ended coupler.

The present invention further relates to a method for building an RFID tag antenna, comprises steps of:

(1) providing an antenna body and a double-open end coupler so as to constitute a tag antenna; where central operating frequency of the antenna is determined up to length of the antenna body;

(2) adjusting a distance between the antenna body and the coupler so as to match a real-part impedance of the tag antenna with a real-part impedance of a chip; and

(3) adjusting a length of the double-open ends of the coupler so as to match an imaginary-part impedance of the tag antenna with an imaginary-part impedance of the chip.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become readily understood from the detailed description given herein below and the accompanying drawings which are given by way of illustration only, and thus are not limitative of the present invention and wherein:

FIG. 1 relates to a diagram of an RFID tag antenna according to the prior art;

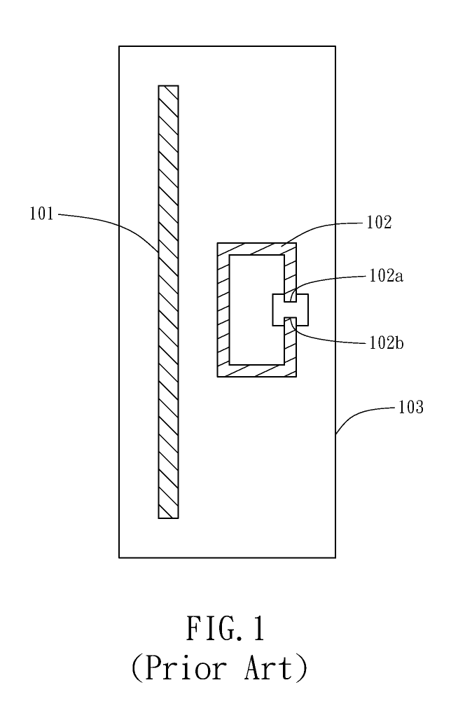

FIG. 1A relates to a plot of bandwidth of operating frequency of an RFID tag antenna according to the prior art;

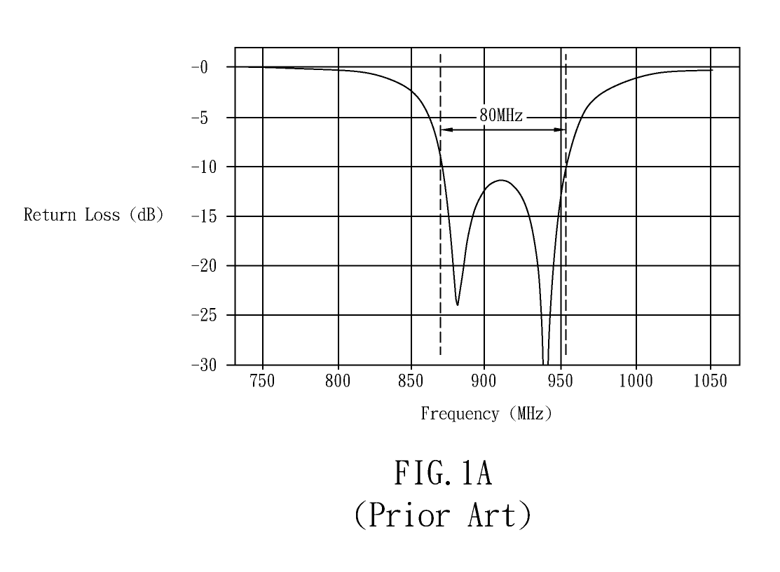

FIG. 2 relates to a view of impedance match between an RFID tag antenna and the chip on the same according to the prior art;

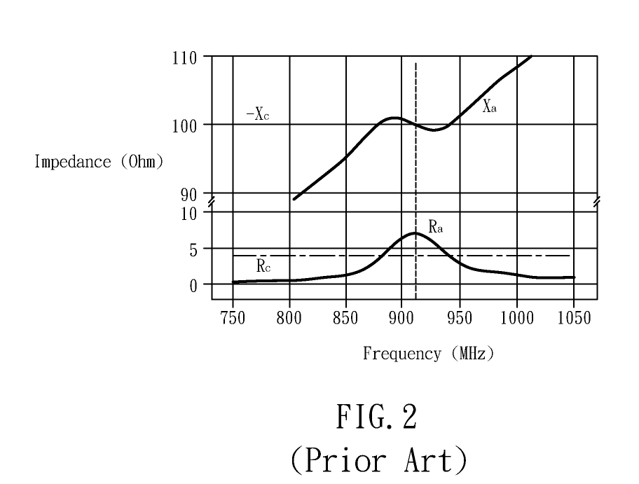

FIG. 3 relates to a view of an RFID tag antenna of a preferred embodiment according to the present invention;

FIG. 3A relates to a view of an RFID tag antenna of another preferred embodiment according to the present invention;

FIG. 4 relates to a plot of an imaginary part of impedance according to the present invention;

FIG. 5 relates to a plot of a real part of impedance according to the present invention;

FIG. 6 relates to a signal plot of the return loss according to the present invention;

FIG. 6A relates to a view of an RFID tag antenna of yet another preferred embodiment according to the present invention;

FIG. 6B relates to a view of an RFID tag antenna of yet another preferred embodiment according to the present invention; and

FIG. 7 relates to a preferred embodiment realized in the form of a patch antenna according to the present invention.

### DESCRIPTION OF THE EXEMPLARY EMBODIMENTS

The following descriptions are of exemplary embodiments only, and are not intended to limit the scope, applicability, or configuration of the invention in any way. Rather, the following description provides a convenient illustration for implementing exemplary embodiments of the invention. Various changes to the described embodiments may be made in the function and arrangement of the elements described. For your esteemed members of reviewing committee to further understand and recognize the fulfilled functions and structural characteristics of the invention, several exemplary embodiments cooperating with detailed description are presented as the follows.

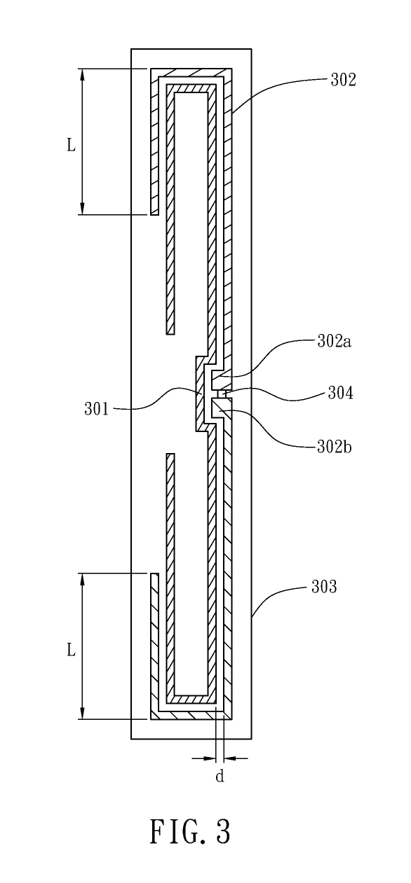

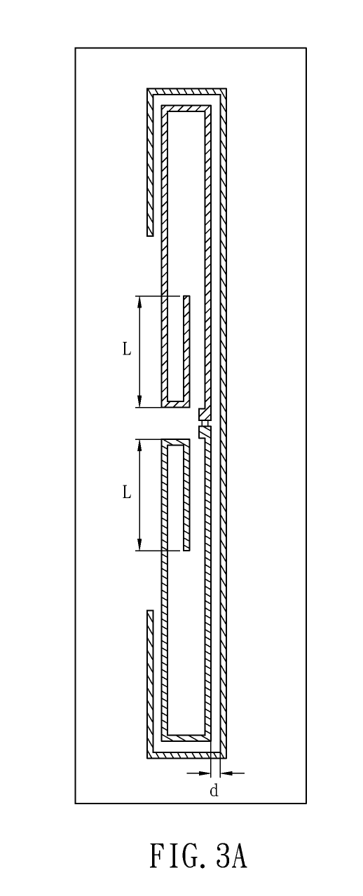

FIG. 3 relates to one of the preferred embodiments of the present invention, which illustrates an antenna body 301, and a double-open ends coupler 302, and both of them can be disposed on a substrate 303. The antenna body 301 and the double-open ends coupler 302 can be a dipole antenna but not limited thereto, and the double-open ends coupler 302 has two input ports 302a/302b disposed on the coupler 302, which are usually disposed at the middle position between the double-open ends, but not limited thereto.

The RFID tag antenna of the preferred embodiment as illustrated in FIG. 3, further comprises an RFID chip 304. The RFID chip 304 uses one pad (electrode) of the input port 302a and another pad (electrode) of the input port 302b to receive or feed in an RF signal.

At this time, the coupler 302 can be designed to be around the antenna body 302, that is, to surround the peripheral of the antenna body or the inner side of the antenna body, as illustrated in FIG. 3A, and the antenna can be operable in UHF band or microwave band.

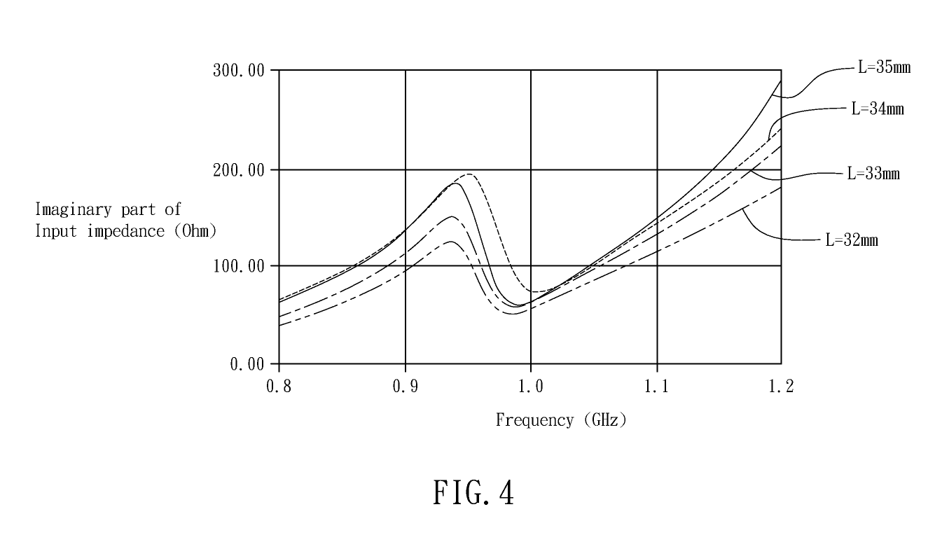

Hereby FIG. 3 further illustrates, in order to achieve the inductive input impedance for the antenna, usually, the total length of the coupler 302 is larger than about a half wavelength. On the contrary, in order to achieve the capacitive input impedance for the antenna, usually, the total length of the coupler 302 is smaller than about a half wavelength. Compared with the conventional impedance match adjustment, the methodology adopted by the present invention, is to achieve the impedance match and meanwhile to take advantage of the better radiation capability of the coupler 302 itself so as to enhance the whole radiation of the antenna. The reactance value for the input impedance of the antenna will be varied according to the variation of coupler's length, which is further illustrated in FIG. 4.

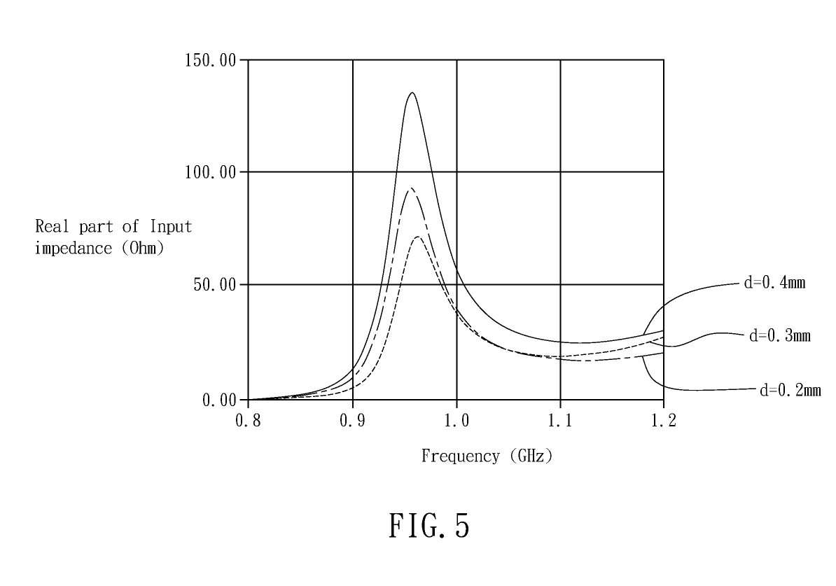

Hereby FIG. 5 further illustrates, in order to make the real part of the impedance of the antenna can achieve the desired resistance, the closer the distance d between the coupler 302 and the antenna body 301 is, the smaller its resistance value is; and the further the distance d between the coupler 302 and the antenna body 301 is, the larger its resistance value is in view achieving the real part of the desired impedance, which is illustrated in FIG. 5.

And it is the most distinguished point between the present invention and the prior art that a double-open ends coupler 302 is used to replace the couple “loop” 102, and the double-open ends coupler 302 can be deemed as a dipole antenna itself and its radiation effect is stronger the aforesaid small-scaled couple loop 102. Hence, the RFID tag antenna using double-open ends coupler structure will be of at least equivalent or better radiation effect or broader bandwidth performance than the aforesaid art.

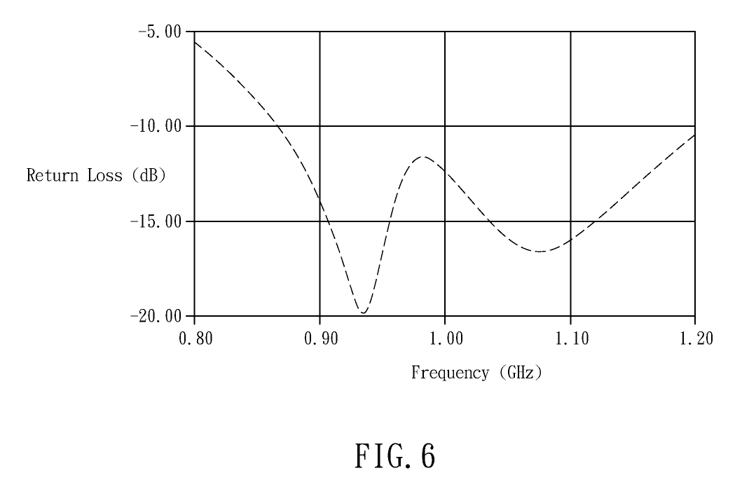

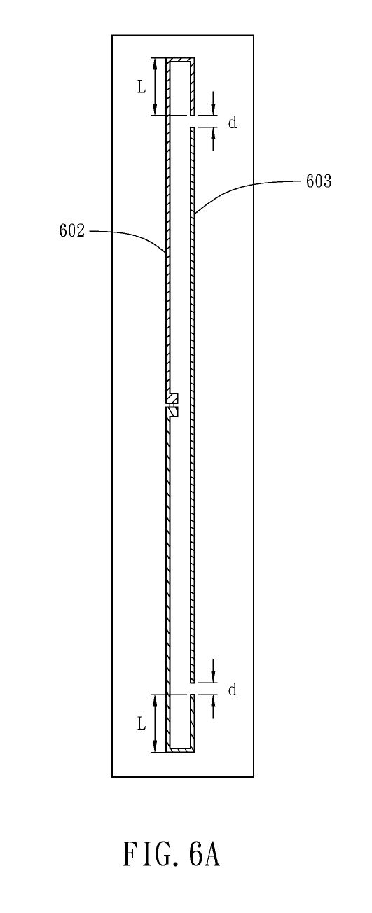

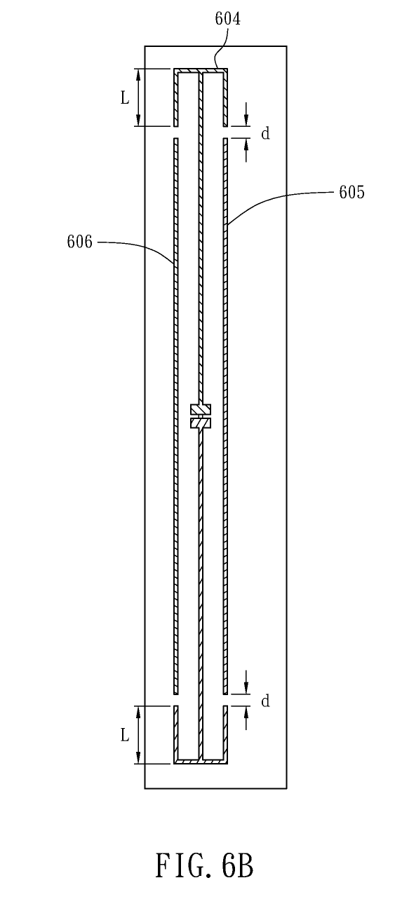

FIG. 6 relates to the signal plot of the return loss for the present invention (the present invention can achieve the bandwidth broader than 10% of the central operating frequency under impedance match).

FIG. 4-6 illustrates an RFID tag antenna operating in UHF band, but the length of the first antenna body can be also adjusted so as to serve the purpose of higher operating frequencies such as 2.45 GHz˜5.8 GHz, and the coupler can be also adjusted accordingly without duplicate description.

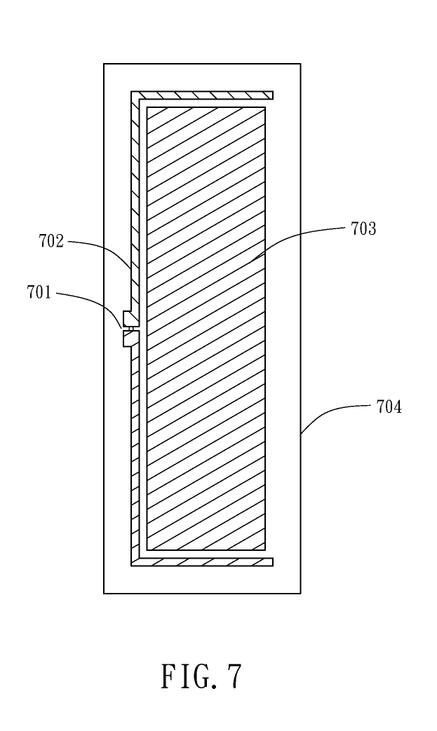

Another one of the embodiments of the present invention, as illustrated in FIG. 6A, discloses an antenna body 603 and a coupler 602 where between said 602 and said 603 the parallel distance can be affixed, however, for the four tail ends of the coupler 604 and the four tail ends of the double antenna bodies 605/606, their distances “d” can be varied. The variation of “d” can serve the same purpose as did in the embodiments of FIG. 3 and FIG. 6, where the lengths of said 605 and 606 are not necessarily identical. The variation, in addition to serve the same purpose, can lead to double coupling so as to increase the operating bandwidth. The aforesaid RFID tag antenna having double-open end coupler 302, can also adopt the form of a micro strip antenna with back ground plane. Similarly, the aforesaid RFID tag antenna having double-open end coupler 302, can also adopt the form of a patch antenna with back ground plane, and in this case, the antenna body 703 itself can be a patch antenna, and its coupler 702 can be a double-open end micro-strip antenna having a chip 701, as illustrated in FIG. 7.

The denoted “L” as illustrated in FIG. 3, FIG. 3A and FIG. 6A/B refers to the lengths between the two ends of the coupler which can be adjusted so as to achieve the goal of adjusting the imaginary part of the parameters for impedance match between the chip and the coupler, and the skilled artisan can vary the same without departing the scope of view of the invention.

The present invention further relates to a method for building an RFID tag antenna, comprises steps of:

(1) providing an antenna body and a double-open ends coupler so as to constitute an antenna; where central operating frequency of the antenna is determined up to the length of the antenna body;

(2) adjusting a distance between the antenna body and the coupler so as to match a real-part impedance of the antenna with a real-part impedance of a chip; and

(3) adjusting a length of the double-open ends of the coupler so as to match an imaginary-part impedance of the antenna with an imaginary-part impedance of the chip.

The invention being thus aforesaid, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. An RFID tag antenna characterized in broad band and high radiation, comprising:
an antenna body; and
a double-open ended coupler.

2. The RFID tag antenna as recited in claim 1, wherein the antenna body is a dipole antenna.

3. The RFID tag antenna as recited in claim 1, further comprising an input port disposed on the coupler.

4. The RFID tag antenna as recited in claim 1, wherein the coupler is a dipole antenna.

5. The RFID tag antenna as recited in claim 3, further comprising a chip, wherein the chip is disposed on the input port of the coupler.

6. The RFID tag antenna as recited in claim 1, wherein a length of the double-open ends coupler is larger than a half wavelength, equals to a half wavelength or is smaller than a half wavelength.

7. The RFID tag antenna as recited in claim 5, a length of the double-open ends coupler can be adjusted so as to achieve a desirable reactance for an input impedance of the input port.

8. The RFID tag antenna as recited in claim 5, a distance between the coupler and the antenna body can be adjusted so as to achieve a desirable resistance for an input impedance of the input port.

9. The RFID tag antenna as recited in claim 1, wherein the RFID antenna can be made of micro-strip antenna or patch antenna.

10. The RFID tag antenna as recited in claim 9, wherein the antenna body is usually a patch antenna, and the coupler is usually a double-open ends micro-strip antenna.

11. A method for building an RFID tag antenna, comprises steps of:
(1) providing an antenna body and a double-open ends coupler so as to constitute a tag antenna; where central operating frequency of the antenna is determined up to length of the antenna body;
(2) adjusting a distance between the antenna body and the coupler so as to match a real-part impedance of the tag antenna with a real-part impedance of a chip; and
(3) adjusting a length of the double-open ends of the coupler so as to match an imaginary-part impedance of the tag antenna with an imaginary-part impedance of the chip.
